(19) United States
(12) Patent Application Publication
(10) Pub. No.: US 2008/0003462 A1
(43) Pub. Date: Jan. 3, 2008

(54) Digital logic control DC-to-DC converter with controlled input voltage and controlled power output

(75) Inventors: Zeev Aleyraz, Herzeliyya (IL); Shemuel Gal, Hadera (IL); Avi Amsili, Nes Ziona (IL); Gai Picha, Givat Shmuel (IL)

Correspondence Address: GREENBLUM & BERNSTEIN, P.L.C., 1950 ROLAND CLARKE PLACE, RESTON, VA, 20191, US

(73) Assignee: More Energy Ltd., Lod (IL)

(21) Appl. No.: 11/476,568

(22) Filed: Jun. 29, 2006

(51) Int. Cl. H01M 8/04; B23K 11/24

(52) U.S. Cl. 429/13; 429/23; 323/318

(57) ABSTRACT

Process and apparatus for powering a powered device with a fuel cell. The process includes maintaining an input voltage, supplied by the fuel cell, to a converter device, and controlling an output power of the converter device, which is coupled to the powered device. The process also includes varying the current drawn from the fuel cell to compensate for fluctuations in the voltage required during operation of the powered device. The instant abstract is neither intended to define the invention disclosed in this specification nor intended to limit the scope of the invention in any way.

### BACKGROUND OF THE INVENTION

1. Field of the Invention

The present invention is directed to a controller for controlling input voltage and output power of a fuel cell.

2. Discussion of Background Information

Fuel cells produce current at low voltages, and tend to operate most efficiently when operated within a specific target voltage range. These ranges can vary depending upon the particular design of the fuel cell and the chemistry of the cell. Moreover, most current electronic devices operate at a specific target voltage and power rating. However, the specific target range of an electronic device is generally greater than the specific target voltage range of a fuel cell.

A DC-to-DC converter is an electronic device for stepping up a low voltage/high current to a higher voltage with lower current. Typically, such a device is specified on how great a boost in voltage is necessary and product efficiency.

The voltage from a fuel cell can be boosted to the target voltage range of an electronic device through a DC-to-DC converter. As operation of the electronic device draws more or less power, a standard DC-to-DC converter will typically maintain the output voltage while the input voltage fluctuates. Thus, as the load varies, the fuel cell can operate in conditions which are not optimum, i.e., less efficient regimes.

### SUMMARY OF THE INVENTION

The present invention is directed to a DC-to-DC converter with a digital controller. The digital controller adjusts an incoming current to maintain the input voltage at a target optimum operating voltage of the fuel cell. As the electronic device draws more or less power, the controller monitors the load change and actively adjusts the incoming current from the fuel cell so that the fuel cell operates at optimum voltage.

The DC-to-DC converter is fed from a fuel cell and is arranged to charge a cell (e.g., super cap, battery, etc.) or drive a device load. However, not only is the DC-to-DC converter intended to operate the device or charge the cell, but also to maintain an optimal operating condition for the fuel cell during the operation or charging.

A fuel cell has an internal resistance of about 0.2Ω, such that it is possible to regulate the input voltage of the converter for a wide range of output load. By regulating input voltage, output power delivered to the load is constant for constant parameters of the fuel cell. This regulation can be provided by sensing the input voltage to the DC-to-DC converter, comparing it to a reference, and adjusting the output voltage through an O/A so that, as the load changes, the input voltage remains constant.

A battery's voltage increases and its current decreases during charging so that the charge power remains constant.

The process ends when the output voltage reaches a maximum value that can be adjusted by resistors and, from that point, the output voltage is constant until the current ceases to flow, i.e., at the no load condition. The input voltage will increase, i.e., no longer be constant, until a maximum of about 0.9 V at no load is attained. In this regard, it is noted that from the V/I curve, V*I is constant from Vmin to Vmax and can be adjusted by resistors. Moreover, as fuel cells increase in temperature, their internal resistances increase (or voltages decrease), whereby the constant output power decreases.

The present invention is directed to a method for controlling the fuel cell output voltage and adjusting the current to maintain the fuel cell at its optimum performance voltage.

Other exemplary embodiments and advantages of the present invention may be ascertained by reviewing the present disclosure and the accompanying drawing.

### BRIEF DESCRIPTION OF THE DRAWINGS

The present invention is further described in the detailed description which follows, in reference to the noted plurality of drawings by way of non-limiting examples of exemplary embodiments of the present invention, in which like reference numerals represent similar parts throughout the several views of the drawings, and wherein:

FIG. 1 illustrates a block diagram of the controller for a fuel cell in either standby mode or no load condition according to the invention;

FIG. 2 illustrates a schematic diagram of the controller;

FIG. 3 schematically illustrates the start and auxiliary booster in accordance with the invention;

FIG. 4 schematically illustrates the driver and multiplier depicted in FIG. 2;

FIG. 5 schematically illustrates an example of a charge pumping capacitor for the multipliers depicted in FIG. 4;

FIG. 6 schematically illustrates an alternative example of a charge pumping capacitor for the multipliers depicted in FIG. 4;

FIG. 7 schematically illustrates alternative driver and multiplier as depicted in FIG. 2;

FIG. 8 schematically illustrates the oscillator and logic circuitry depicted in FIG. 2;

FIG. 9 schematically illustrates the boost converter circuitry depicted in FIG. 2;

FIG. 10 schematically illustrates the tune to convert circuitry depicted in FIG. 2;

FIG. 11 schematically illustrates a parallel arrangement of VLSI modules; and

FIG. 12 schematically illustrates a series arrangement of VLSI modules.

### DETAILED DESCRIPTION OF THE PRESENT INVENTION

The particulars shown herein are by way of example and for purposes of illustrative discussion of the embodiments of the present invention only and are presented in the cause of providing what is believed to be the most useful and readily understood description of the principles and conceptual aspects of the present invention. In this regard, no attempt is made to show structural details of the present invention in more detail than is necessary for the fundamental understanding of the present invention, the description taken with the drawings making apparent to those skilled in the art how the several forms of the present invention may be embodied in practice.

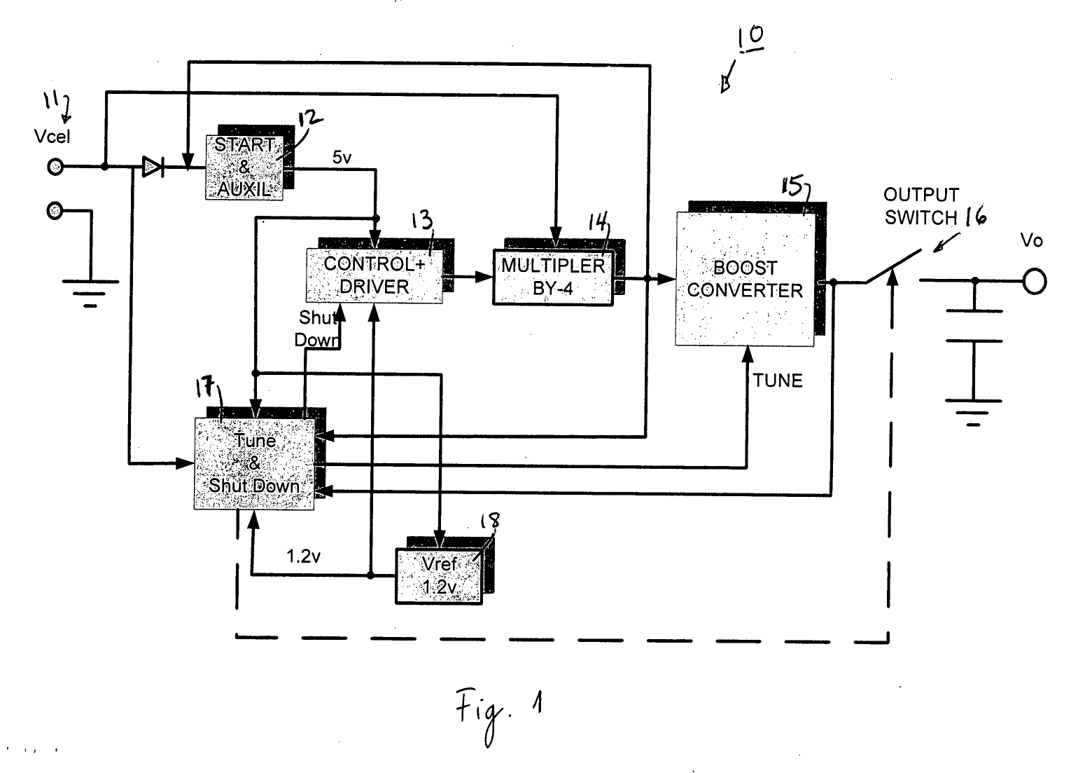

The present invention is directed to a converter for supplying a desire output to a load from a fuel cell, e.g., a direct hydride fuel cell (DHFC), and a process for adjusting current from the fuel cell to maintain the fuel cell voltage within an optimum target range. According to the invention, the present converter saves power, i.e., consumes small power out, and is highly efficient, i.e., about 90%, which is not available in the market. Of course, it is understood that other fuel cell chemistries can be utilized without departing from the scope and spirit of the invention, e.g., PEM, DMFC, AFC, etc. A block diagram of converter 10 is illustrated in FIG. 1. Converter 10 can be coupled to a fuel cell, e.g., a DHFC, at input terminals 11. At a no load condition, the fuel cell will generally exhibit an input voltage Vcel at terminals 11 of 0.85-0.95 V, but during operation, Vcel can fluctuate between 0.4 and 0.8 V, with a Vcel of 0.6 V being an optimum input voltage. Vcel at terminals 11 is applied through a diode to a start and auxiliary booster 12, which is provided to boost the input voltage to levels sufficient to operate converter 10. Thus, when converter 10 starts, start and auxiliary booster 12 increases the input voltage Vcel to between 2.4 and 3.0 V in order to operate the converter and provide the desired output to a load, e.g, a powered device or a charging device. The boosted voltage is applied to control and driver 13, which can be, e.g., a pulse width modulation (PWM) chip with a 25 kHz oscillator, E/A, and a push-pull drive. Controller 13 is arranged to activate multiplier 14, which may be a multiply by 4 device, which receives and multiplies input voltage Vcel. Multiplier 14 can be an 8 bit switching capacitor, i.e., a charge pumping capacitor, composed of metal oxide semiconductor field effect transistors (MOSFETs) and capacitors.

The multiplied voltage from multiplier 14 is applied to boost converter 15 in order to boost the voltage to levels required by the load. Thus, depending upon the load, the output voltage of boost converter 15 is generally between 3.5 and 5.5 V. Converter 10 can be utilized to supply power for charging lithium ion (Li-ion) batteries for cell phones and the like. Boost converter 15, which can be formed, e.g., by a conventional integrated circuit chip, is provided to vary the output voltage, whereby input voltage Vcel can remain constant at about 0.6 V.

Boost converter 15 is coupled to a switch 16, e.g., a p-channel MOSFET, which is OFF at start up and remains closed until the voltage output of boost converter 15 is sufficient for the requirements of the powered device or charging device. Once the required voltage is achieved by boost converter 15, e.g., 5.4-5.5 V, switch 16 turns ON to supply this voltage as output voltage Vo of converter 10 to the load, i.e., a powered device or charging device.

A tune and shut down 17 receives input voltage Vcel, the output voltage of multiplier 14 and the output voltage of boost converter 15 in order to, if necessary, instruct control and driver 13 to shut down and tune boost converter 15. Tune and shut down 17 is also coupled to switch 16, which closes to connect converter 10 to the load Vo, e.g., a powered device such as a cell phone, laptop computer, PDA, chargers, etc., through a parallel capacitor. Tune and shut down 17 monitors input voltage Vcel and regulates it for output and current variations due to the load. Thus, tune and shut down 17 monitors the voltage levels to ensure that the voltage required by the load is attained before switch 16 is turned ON, and that input voltage Vcel is maintained constant while the requirements of the load vary. As a result, output power is almost constant during all charge cycles until the output voltage exceeds 5.4 V. Moreover, when the output voltage of multiplier 14 exceeds, e.g., 2.4 V at no load, tune and shut down 17 can instruct control and driver 13 to shut down the MOSFET gate pulses of multiplier 14 in order to save power. To ensure proper control, tune and shut down 17 receives a reference voltage of, e.g., 1.2 V from Vref 18, which is a sufficient voltage to tune boost converter 15, to shut down control and driver 13, and to activate switch 16.

Accordingly, converter 10 provides maximum allowable current to the load, but does not reduce output voltage below 3.2 V. However, the current from converter 10 is preferably limited so that not more than 1 W of power can be taken from the cell.

Thus, by way of example of operation, at steady state, the load on converter 10 is 1 W, and, during operation, Vcel drops to 0.6 V, is multiplied to 2.4 V and boosted to 5.5 V for the load. Converter 10 supplies the maximum current to the load based upon the load's requirements, and varies the boost voltage accordingly to ensure maximum current supply. However, if more than 1 W is drawn from the cell, voltage can be reduced until 3.2 V. Thereafter, the amount of current supplied will have to be adjusted while the boosted voltage remains at the minimum level of 3.2 V.

As is known, charging of Li-ion batteries is strictly regulated due to their instability, i.e., such batteries charged above 4.2 V or below 2.7 V can explode. For this reason, converter 10 supplies a minimum voltage of 3.2 V and a maximum voltage of 4.2 V to the batteries during charging. Of course, due to voltage drops within the phone, generally 4.8 V are supplied to the phone in order to charge the Li-ion battery.

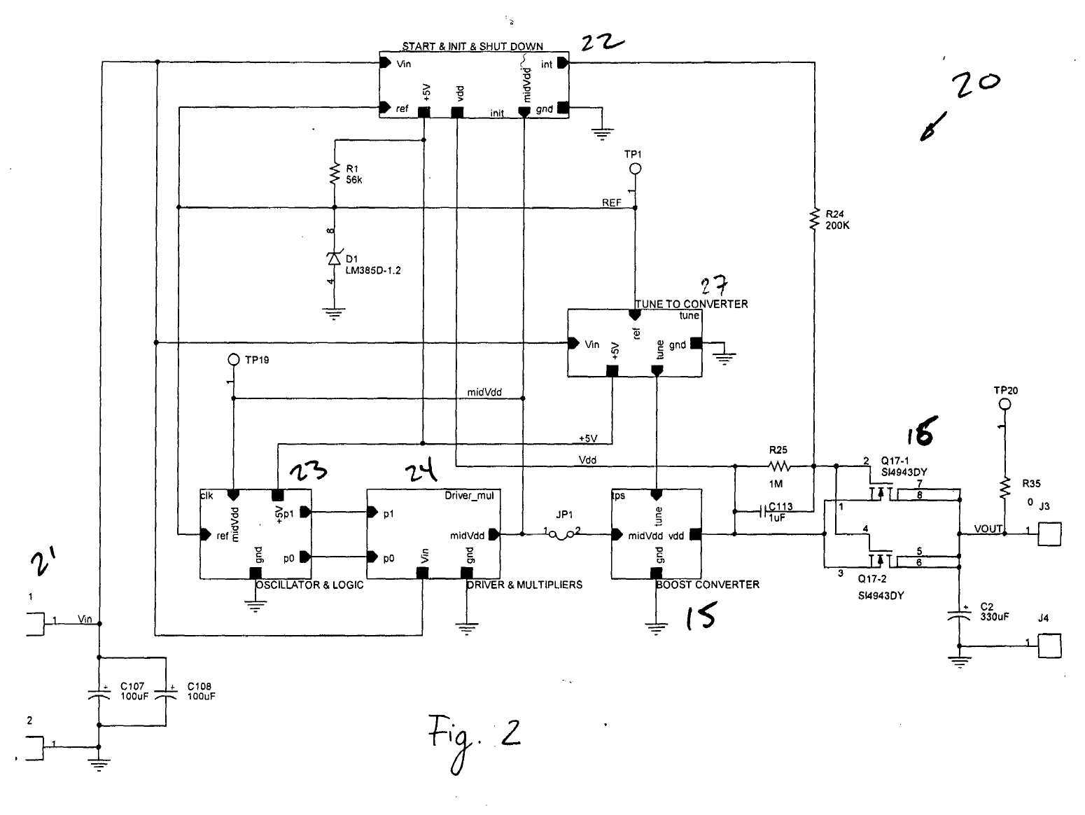

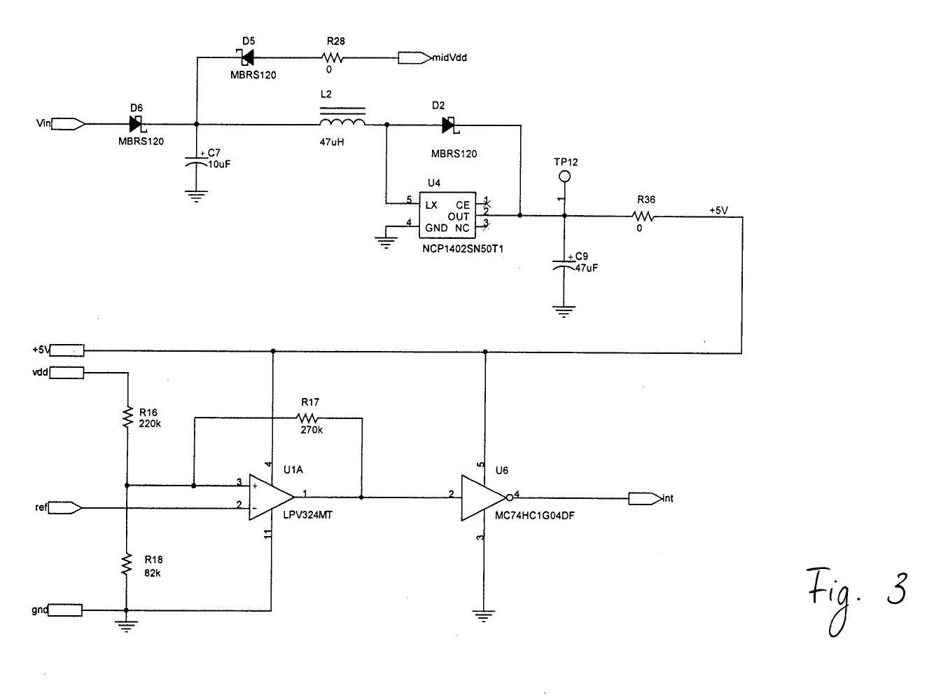

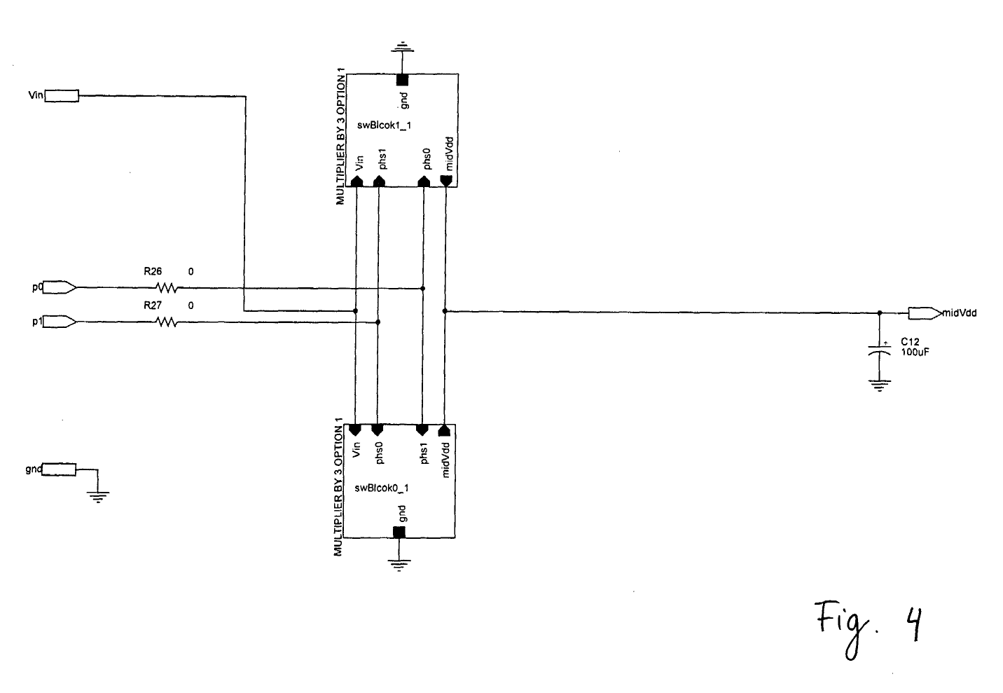

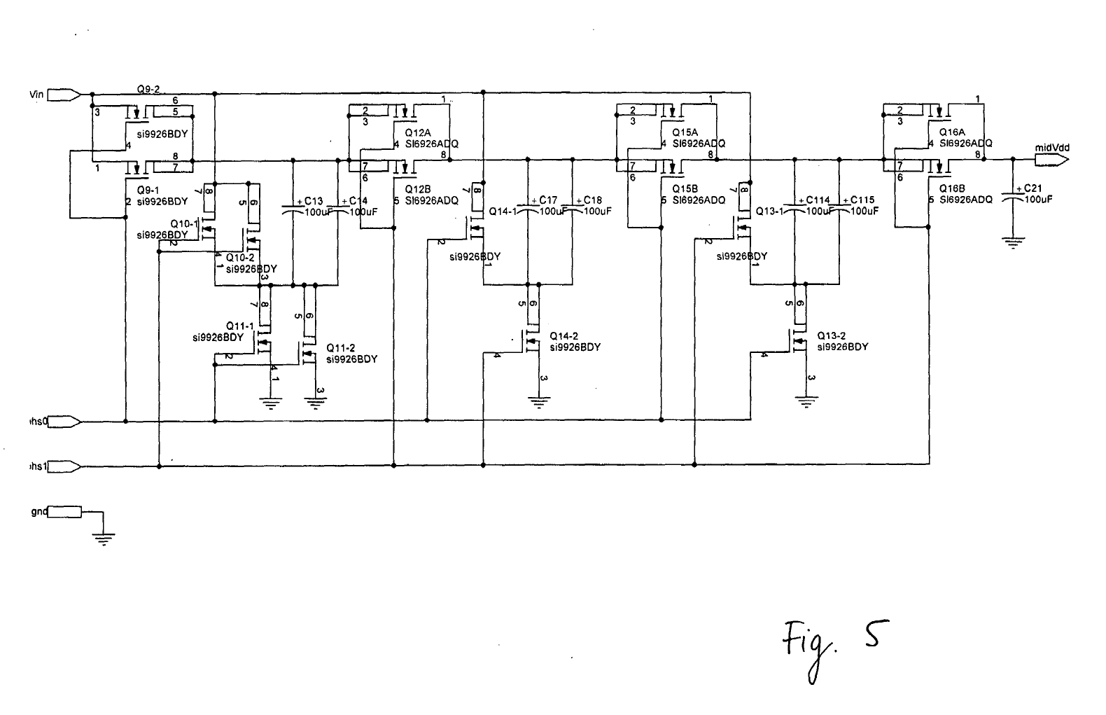

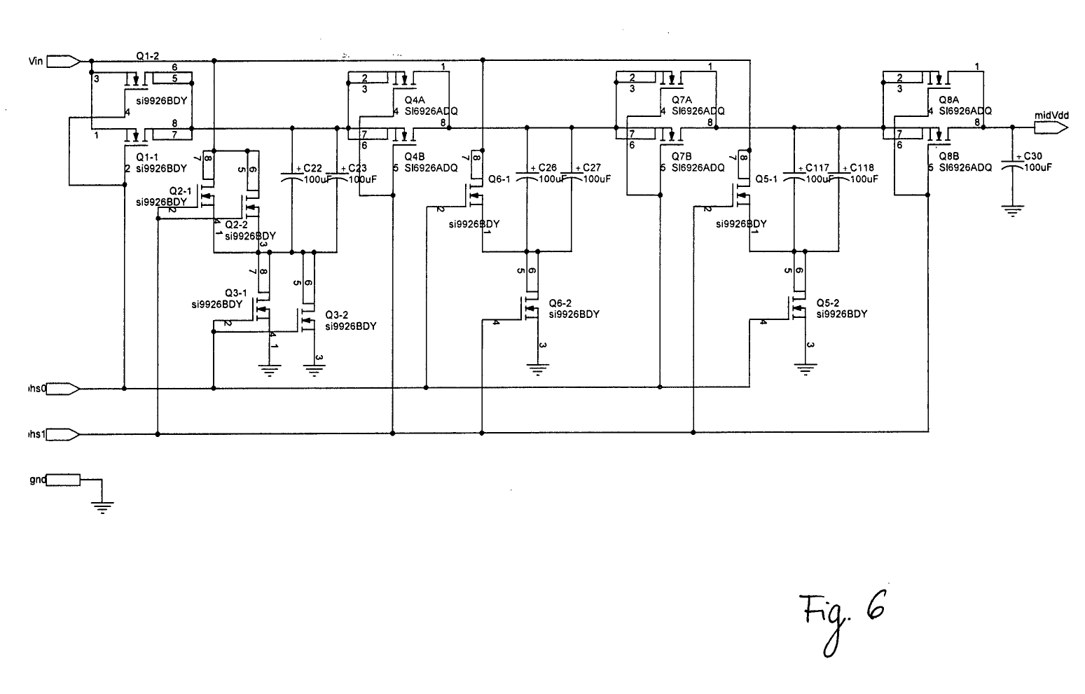

A schematic illustration of the controller 20 of the instant invention is shown in FIG. 2. The fuel cell to be coupled to a powered device is coupled between contacts Vin and gnd. As illustrated, a parallel arrangement of capacitors is arranged in parallel to contacts Vin and gnd, i.e., to the fuel cell. As discussed above, the fuel cell is coupled to start and auxiliary booster oscillator 22, which can be formed, e.g., by the circuit schematically shown in FIG. 3, and to driver and multiplier circuit 24, which can be formed, e.g., by the driver and multiplier circuit schematically shown in FIG. 4, to multiply the voltage by four (4). As discussed above, driver and multiplier circuit 24 can utilize a switching capacitor or charge pumping capacitor including circuitry for multiplying by three (3) in order to achieve the desired multiply by four (4). According to the invention, the multiplication by three (3) can be achieve through the charge pumping capacitor illustrated in FIG. 5 or through the charge pumping capacitor illustrated in FIG. 6.

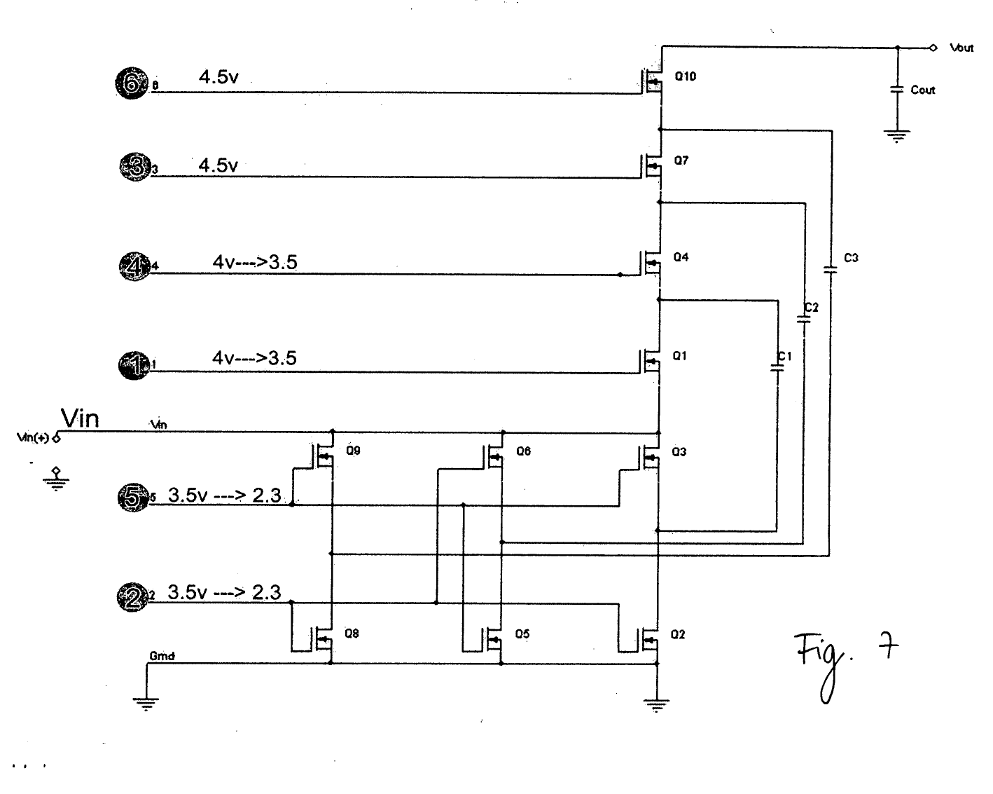

In a further exemplary embodiment, driver and multiplier circuit 24 can be formed by the multiplier circuit 70 shown in FIG. 7. Multiplier circuit 70, which multiplies an input voltage Vin by a factor of four (4), includes three internal capacitors C1, C2, and C3 that are charged and discharged via 10 MOSFETs Q1-Q10 at a frequency of 500 kHz in two phases. Each phase lasts for 2 μsec with a 50% duty cycle with a dead time of 100 nsec between them. Moreover, each phase includes three separated inputs with different voltage levels to ensure a good saturation of the relevant MOSFETs. In general, the input voltage Vin is between about 0.5 and 0.8 V, while the output power is between about 0 and 1.2 W. Further, the multiplier efficiency is about 92% at 1 W, and the output ripple is about 100 mV PTP.

The first phase is connected to the gates of MOSFETs Q1, Q2, Q6, Q7, and Q8 via inputs 1, 2, and 3, while the second phase is connected to the gates of MOSFETs Q3, Q4, Q5, Q9, and Q10 via inputs 4, 5, and 6. At steady state, capacitor C1 is charged to Vin, capacitor C2 is charged to 2Vin, capacitor C3 is charged to 3Vin, and Cout, i.e., the output capacitor, is charged to 4Vin, as required by the multiplier.

Multiplier circuit 70 operates as follows. When phase 1 is initiated, MOSFETs Q1 and Q2 are turned on to charge capacitor C1 to input voltage Vin, and when phase 2 is initiated, MOSFETs Q3, Q4, and Q5 are turned on to charge capacitor C2 to 2Vin (Vin+VC1). When phase 1 returns, MOSFETs Q6, Q7, and Q8 are turned on to charge capacitor C3 to 3Vin (Vin+VC2), and when phase 2 returns, MOSFETs Q9 and Q10 are turned on to charge capacitor Cout to 4Vin (Vin+VC3).

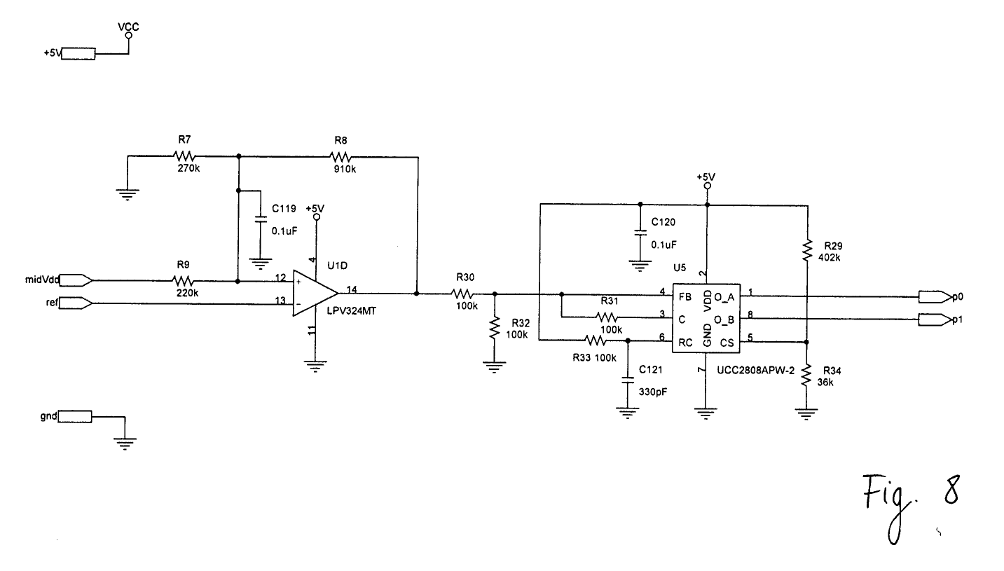

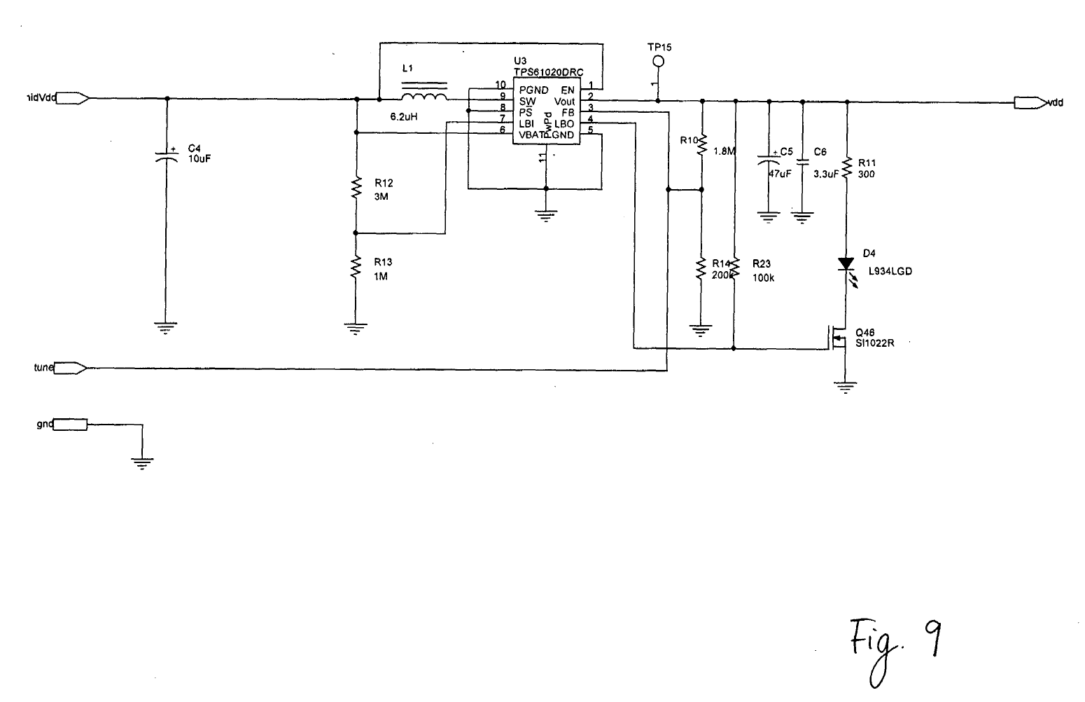

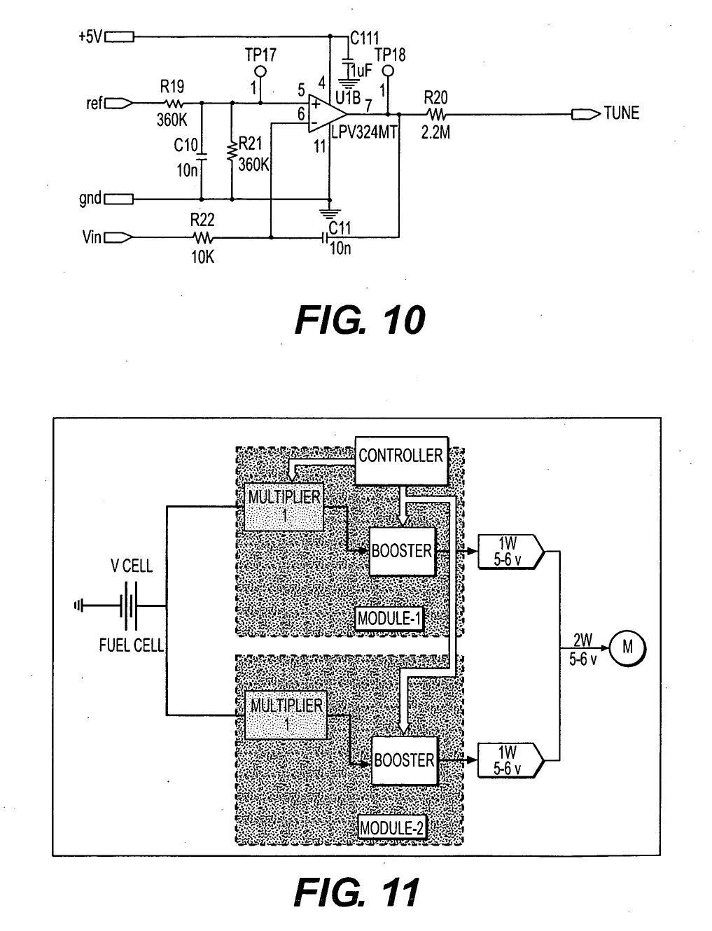

As shown in the schematic diagram of FIG. 2, oscillator and logic 23, which can be formed, e.g., by the circuit illustrated in FIG. 7, is coupled to multiplier 24. Multiplier 24 and tune to converter 27, which can be formed, e.g., by the circuit illustrated in FIG. 8, are coupled to boost converter 25, which can be formed, e.g., by the circuit illustrated in FIG. 9. Moreover, boost converter 25 and start and auxiliary booster 22 are coupled to switching device 26 to supply power of the fuel cell to the powered device.

It is contemplated that controller 20 can be integrated onto a single chip, which is either fixed or programmable, or into a VLSI module. Moreover, controller 20 can be built into or external to the fuel cell, and the chip on which controller 20 is integrated can include other controllers or converters.

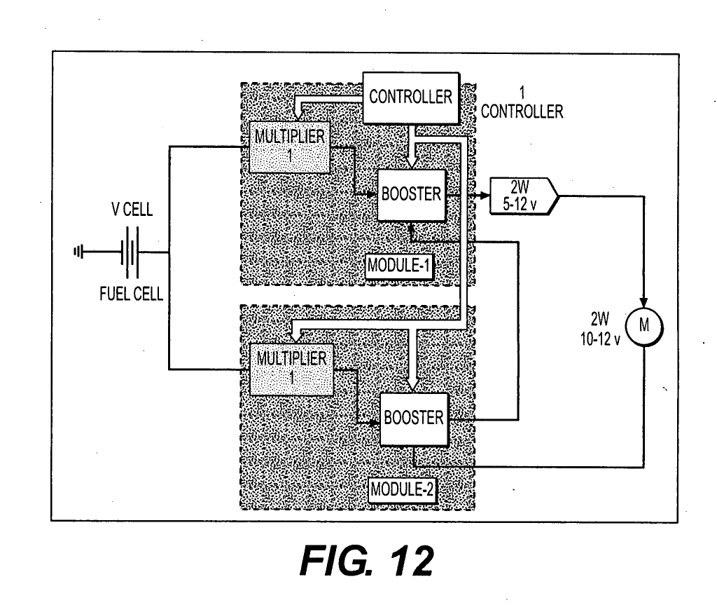

FIGS. 11 and 12 schematically illustrates two VLSI modules, which can be formed with the controller included or without the controller, having an output power of 1 W. In this regard, it is noted that module containing the controller can support up to ten (10) modules without controllers, such that it is not necessary that each module include a controller. Further, the modules can be designed for a stacking (Lego) connection.

By connecting the modules in parallel as shown in FIG. 11, the output power can be increased to 2 W. Further, connecting the modules in series as shown in FIG. 12, the output power can also be increased to 2 W. It is further contemplated that, connecting the modules in serial and/or parallel can increase the output voltage and output power to 12 W. Moreover, with a proper mix connection, i.e., serial and parallel, output power can be increased to 20 W.

It is noted that the circuits depicted in the Figures are for the purposes of illustration and should not be considered as limiting. Thus, is it to be understood that other circuits and arrangements for monitoring the standby mode/no load condition of a fuel cell and for drawing an intermittent pulse from the fuel cell in order to relieve membrane blocking in accordance with the invention can be utilized without departing from the scope and spirit of the invention.

It is noted that the foregoing examples have been provided merely for the purpose of explanation and are in no way to be construed as limiting of the present invention. While the present invention has been described with reference to an exemplary embodiment, it is understood that the words which have been used herein are words of description and illustration, rather than words of limitation. Changes may be made, within the purview of the appended claims, as presently stated and as amended, without departing from the scope and spirit of the present invention in its aspects. Although the present invention has been described herein with reference to particular means, materials and embodiments, the present invention is not intended to be limited to the particulars disclosed herein; rather, the present invention extends to all functionally equivalent structures, methods and uses, such as are within the scope of the appended claims.

What is claimed:

1. A process for powering a powered device with a fuel cell, comprising:
maintaining an input voltage, supplied by the fuel cell, to a converter device;
controlling an output power of the converter device, which is coupled to the powered device;
varying the current drawn from the fuel cell to compensate for fluctuations in the voltage required during operation of the powered device.

2. The process in accordance with claim 1, further comprising sensing a no load condition, and shutting down the converter in response to the no load condition.

3. The process in accordance with claim 1, further comprising not electrically connecting the converter and the powered device until the output power is sufficient to power the powered device.

4. The process in accordance with claim 1, wherein no more than 1 W of power is drawn from the fuel cell.

5. An apparatus for powering a powered device with a fuel cell in accordance with the process of claim 1, the device comprising:
a start and auxiliary booster to increase the input voltage supplied by the fuel cell to a level sufficient to operate the converter;
a multiplier arranged to multiply the input voltage; and
a boost converter to adjust the multiplied voltage to the output power required by the powered device.

6. The apparatus in accordance with claim 5, further comprising an output switch structured and arranged not to electrically connect the converter and powered device until the to the to remain open until the output power corresponds to the output power required by the powered device.

7. The apparatus in accordance with claim 5, wherein the start and auxiliary booster, the multiplier, and boost converter are formed onto an integrated circuit chip.

8. The apparatus in accordance with claim 7, wherein the integrated circuit chip is built into the fuel cell.

9. The apparatus in accordance with claim 7, wherein the integrated circuit chip is external to the fuel cell.

10. A process for coupling a fuel cell to a load, the process comprising:
boosting an output voltage of a fuel cell to a target voltage for a powered device; and
adjusting the amount of current drawn from the fuel cell to compensate for fluctuations in the target voltage.

11. The process in accordance with claim 7, wherein a constant output voltage of the fuel cell is maintained during the target voltage fluctuations.

12. An apparatus for coupling a fuel cell to a load, comprising:
a device structured and arranged to boost an output voltage of a fuel cell to a target voltage for a powered device; and
a device structured and arranged to maintain a constant output voltage of the fuel cell while the target voltage of the powered device fluctuates.

13. The apparatus in accordance with claim 12, wherein the device to maintain the constant output voltage comprises a unit to adjust an amount of current drawn from the fuel cell while the target voltage of the powered device fluctuates.

14. The apparatus in accordance with claim 13, wherein the start and auxiliary booster, the multiplier, and boost converter are formed onto an integrated circuit chip.

15. The apparatus in accordance with claim 14, wherein the integrated circuit chip is built into the fuel cell.

16. The apparatus in accordance with claim 14, wherein the integrated circuit chip is external to the fuel cell.
